(19) United States
(12) Patent Application Publication
(10) Pub. No.: US 2024/0256849 A1
(43) Pub. Date: Aug. 1, 2024

(54) METHODS AND SYSTEMS FOR PERFORMING CONVOLUTIONS USING OPTICAL NETWORKS

(71) Applicant: Raytheon Company, Tewksbury, MA (US)

(72) Inventor: Ping Piu KUO, San Diego, CA (US)

(21) Appl. No.: 18/633,306

(22) Filed: Apr. 11, 2024

Related U.S. Application Data
(63) Continuation of application No. PCT/US2022/050619, filed on Nov. 21, 2022.
(60) Provisional application No. 63/283,951, filed on Nov. 29, 2021.

(51) Int. Cl. G06N 3/067; G06N 3/0464

(52) U.S. Cl. CPC G06N 3/0675; G06N 3/0464

(57) ABSTRACT

An apparatus includes a frequency comb configured to generate first carrier signals having at least one first frequency spacing. The apparatus also includes multiple modulators each configured to modulate an amplitude of one of the first carrier signals and generate a modulated carrier signal. The apparatus further includes a two-dimensional array of optical couplers configured to perform one-dimensional discrete Fourier transforms in a first direction using the modulated carrier signals. The apparatus also includes an array of coherent detectors and first demultiplexers optically coupled to outputs of the array of optical couplers and to the coherent detectors. The apparatus further includes a local oscillator (LO) bank or array configured to generate second carrier signals having at least one second frequency spacing different from the at least one first frequency spacing. In addition, the apparatus includes second demultiplexers optically coupled to outputs of the LO bank or array and to the coherent detectors.

### CROSS-REFERENCE TO RELATED APPLICATION AND PRIORITY CLAIM

This application is a bypass continuation of International Patent Application No. PCT/US2022/050619 filed on Nov. 21, 2022, which claims the benefit of U.S. Provisional Patent Application No. 63/283,951 filed on Nov. 29, 2021. Both of these applications are hereby incorporated by reference in their entirety.

### TECHNICAL FIELD

This disclosure is generally directed to optical systems. More specifically, this disclosure is directed to methods and systems for performing convolutions using optical networks.

### BACKGROUND

Convolutional neural networks (CNNs) have applications in various imaging, recommendation, language processing, and other systems. Many convolutional neural networks employ matrix-form convolutions in order to simplify hardware designs. In these approaches, convolution kernels (weight maps) and input feature maps may be transformed into Toeplitz matrices and vectors, where multiplication of a Toeplitz matrix and a vector yields a desired convolution sum. However, these matrix-form convolution techniques are generally inefficient in terms of data size. For example, for an identical weight map and input feature map of size N×N, the memory needed to store the Toeplitz matrix can expand from 2N² to N⁴. Reducing the size of the Toeplitz matrix may result in an increase in power consumption due to duplication and distribution of large input data blocks at high refresh rates.

### SUMMARY

This disclosure relates to methods and systems for performing convolutions using optical networks.

In a first embodiment, an apparatus includes a frequency comb configured to generate multiple first carrier signals having at least one first frequency spacing. The apparatus also includes multiple modulators configured to modulate the first carrier signals, where each modulator is configured to modulate a corresponding one of the first carrier signals based on a time series of values from a corresponding portion of a matrix. In addition, the apparatus includes an array of optical couplers configured to perform one-dimensional (1D) discrete Fourier transforms of the portions of the matrix using the modulated first carrier signals, where the array of optical couplers is configured to output a time series of 1D Fourier coefficients for each time series of values from the corresponding portion of the matrix.

In a second embodiment, an apparatus includes a frequency comb configured to generate first carrier signals having at least one first frequency spacing. The apparatus also includes multiple modulators each configured to modulate an amplitude of one of the first carrier signals and generate a modulated carrier signal. The apparatus further includes a two-dimensional (2D) array of optical couplers configured to perform 1D discrete Fourier transforms in a first direction using the modulated carrier signals. The apparatus also includes an array of coherent detectors and first demultiplexers optically coupled to outputs of the array of optical couplers and to the coherent detectors. The apparatus further includes a local oscillator (LO) bank or array configured to generate second carrier signals having at least one second frequency spacing different from the at least one first frequency spacing. In addition, the apparatus includes second demultiplexers optically coupled to outputs of the LO bank or array and to the coherent detectors.

In a third embodiment, a method includes obtaining an input feature map and generating, using an optical network, a 2D discrete Fourier transform of the input feature map to produce a Fourier-space input feature map. The method also includes obtaining a Fourier-space weight map based on a weight map and performing a Hadamard multiplication of the Fourier-space input feature map and the Fourier-space weight map.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example process for performing convolution in a Fourier domain;

FIG. 2 illustrates an example process for performing a hybrid two-dimensional discrete Fourier transform according to this disclosure;

FIGS. 3A and 3B illustrate an example mathematical construct for computing a one-dimensional discrete Fourier transform and an example optical system that implements the one-dimensional discrete Fourier transform according to this disclosure;

FIGS. 4A and 4B illustrate an example two-dimensional discrete Fourier transform computation using an optical system and an example frequency spectrum associated with the two-dimensional discrete Fourier transform according to this disclosure;

FIGS. 5A through 5E illustrate another example two-dimensional discrete Fourier transform computation using an optical system and example frequency spectra associated with the two-dimensional discrete Fourier transform according to this disclosure;

FIG. 6 illustrates an example implementation of a column discrete Fourier transform block according to this disclosure;

FIG. 7 illustrates an example implementation of a column discrete Fourier transform block incorporating weighting according to this disclosure; and

FIG. 8 illustrates an example method for performing convolutions using an optical network according to this disclosure.

### DETAILED DESCRIPTION

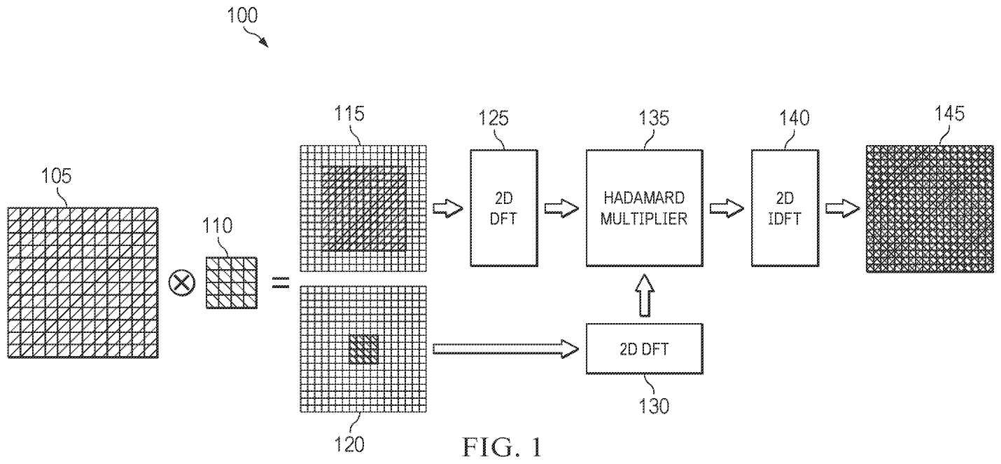

FIGS. 1 through 8, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, convolutional neural networks (CNNs) have applications in various imaging, recommendation, language processing, and other systems. Many convolutional neural networks employ matrix-form convolutions in order to simplify hardware designs. In these approaches, convolution kernels (weight maps) and input feature maps may be transformed into Toeplitz matrices and vectors, where multiplication of a Toeplitz matrix and a vector yields a desired convolution sum. However, these matrix-form convolution techniques are generally inefficient in terms of data size. For example, for an identical weight map and input feature map of size N×N, the memory needed to store the Toeplitz matrix can expand from 2N² to N⁴. Reducing the size of the Toeplitz matrix may result in an increase in power consumption due to duplication and distribution of large input data blocks at high refresh rates.

This disclosure provides various methods and systems for performing signal processing and other operations that involve convolutions of matrices. As described in more detail below, these methods and systems enable the determination of a convolution of two matrices. By way of example, embodiments of this disclosure provide methods and systems for performing convolutions using optical networks. The methods and systems described here can be applied to a variety of computational systems, including systems useful in image processing, pattern analysis, signature recognition, recommendation, language processing, and the like. Various benefits or advantages can be achieved using the methods and systems described in this disclosure compared to prior approaches. For instance, embodiments of this disclosure can compute convolutions of matrices with significantly reduced computational loads and memory requirement by using optical systems to perform Fourier transforms in the optical domain. Additional features, benefits, and advantages of the various embodiments of this disclosure are described in more detail below.

Note that while it may often be assumed in the discussion below that optical systems are being used to perform convolutions for convolutional neural networks, this is for illustration and explanation only. The methods and systems described in this disclosure may be used to perform any desired convolutions of matrices for any suitable purposes. As a result, while the methods and systems described in this disclosure may be used to perform convolutions of matrices for convolutional neural networks, the methods and systems described in this disclosure may be used in any other suitable applications.

FIG. 1 illustrates an example process 100 for performing convolution in a Fourier domain. In other words, the process 100 of FIG. 1 is used for performing convolution in the frequency domain. As shown in FIG. 1, the process 100 for performing convolution generally operates using an input feature map 105 and a weight map 110. The input feature map 105 generally represents a collection of features associated with input data being processed, such as features of one or more images, audio samples, or other input data. The input feature map 105 is often produced using a feature extractor, which may represent at least part of a machine learning model that has been trained to extract features determined to be relevant for a particular task. The weight map 110 generally represents a collection of weights to be applied to the input feature map 105. The weights of the weight map 110 may be determined in any suitable manner, such as when the weights are determined during training of a machine learning model.

As can be seen in FIG. 1, the input feature map 105 may be zero-padded to form a zero-padded input feature map 115, and the weight map 110 may be zero-padded to form a zero-padded weight map 120. The zero-padding operations here can involve adding additional entries containing “zero” values around the entries of the input feature map 105 and the weight map 110. Among other things, zero-padding can be used to address aliasing that occurs as a result of the Fourier transform process, since the input feature map 105 and the weight map 110 are not assumed to be periodic. Zero-padding can increase the data size of the zero-padded input feature map 115 and the zero-padded weight map 120 relative to the original input feature map 105 and weight map 110. However, the impact is generally small for a small weight map 110 (as compared to traditional convolution methods that use Toeplitz matrices and matrix multiplication) and may not be implemented if the boundaries are discarded.

The zero-padded input feature map 115 and the zero-padded weight map 120 may be fed into a first two-dimensional (2D) discrete Fourier transform (DFT) unit 125 and a second 2D discrete Fourier transform unit 130, respectively. The discrete Fourier transform units 125 and 130 respectively operate to convert the zero-padded input feature map 115 and the zero-padded weight map 120 into the Fourier domain (frequency domain). Note that, in some cases, the 2D discrete Fourier transform performed on the weight map 110 or 120 may be performed digitally and stored in memory. This is because, for many applications, the weight matrix is the same for different input feature maps 105. In these embodiments, the results of the 2D discrete Fourier transform performed on the weight map 110 or 120 may be retrieved from memory and used whenever additional input feature maps 105 are obtained and processed.

Once the zero-padded input feature map 115 and the zero-padded weight map 120 are converted into the Fourier domain, these maps (now in the frequency domain) may be fed into a Hadamard multiplier 135. The Hadamard multiplier 135 generally operates to perform an element-wise multiplication of the two frequency-domain maps. In order to convert the results generated by the Hadamard multiplier 135 back into the spatial domain, outputs of the Hadamard multiplier 135 may be fed into an 2D inverse discrete Fourier transform (IDFT) unit 140. The inverse discrete Fourier transform unit 140 converts the results generated by the Hadamard multiplier 135 into the spatial domain. The output of the inverse discrete Fourier transform unit 140 is an output matrix 145 representing the convolution of the input feature map 105 and the weight map 110.

In this way, the process 100 shown in FIG. 1 can be used to implement convolution in the Fourier domain. Performing convolution in the Fourier (frequency) domain can help to reduce the complexity of the convolution compared to conventional matrix multiplication approaches. For example, by performing convolution in the Fourier domain, circular-shift multiply-add operations in convolution become Hadamard multiplication (element-wise multiplication) operations in the Fourier domain. However, performing the 2D discrete Fourier transforms using the discrete Fourier transform units 125 and 130, as well as performing the 2D inverse discrete Fourier transform using the inverse discrete Fourier transform unit 140, are computationally expensive using conventional techniques. Even approaches that use graphics processing units (GPUs), which may typically be implemented using application specific integrated circuits (ASICs), may suffer from high computational loads. In order to implement Fourier-domain convolution in a more effective manner, elements of the process 100 illustrated in FIG. 1 can be performed using one or more optical systems that provide reductions in computational expenses and memory resources.

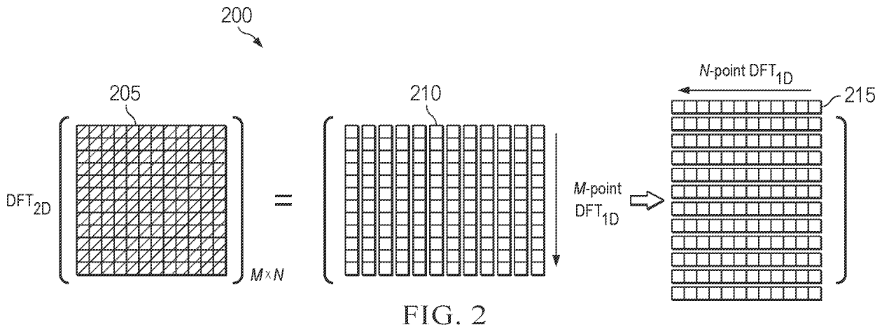

FIG. 2 illustrates an example process 200 for performing a hybrid 2D discrete Fourier transform according to this disclosure. As shown in FIG. 2, a 2D discrete Fourier transform may be implemented using two cascaded one-dimensional (1D) discrete Fourier transforms. In this example, an input feature map 205 (which may represent the input feature map 105 or the zero-padded input feature map 115 described above) is a matrix with a size of M×N, meaning the input feature map 205 has M rows and N columns of matrix elements. The input feature map 205 here may be decomposed into a set of column-wise vectors 210. That is, each column of the input feature map 205 can be used to form a separate vector 210 in the set of column-wise vectors 210.

A 1D discrete Fourier transform (such as an M-point 1D discrete Fourier transform) may be performed across the first dimension of the input feature map 205, such as when the first 1D discrete Fourier transform is performed on each vector 210 in the set of column-wise vectors 210. The first 1D discrete Fourier transform is therefore denoted as “M-point DFT_{1D}” in FIG. 2. Here, the values in a given column are used to perform the M-point discrete Fourier transform, which may also be referred to as a “Row DFT” since the values in all rows of a given column are used in the discrete Fourier transform. The outputs of the first 1D discrete Fourier transform may be arranged as a set of row-wise vectors 215. For instance, the first element in each of the column vectors obtained as the output of the first 1D discrete Fourier transform may be grouped to be a first row-wise vector 215, and subsequent row-wise vectors 215 may be obtained by grouping the n^{th} element in each of the column vectors obtained as the output of the first 1D discrete Fourier transform.

A second 1D discrete Fourier transform (such as an N-point 1D discrete Fourier transform) may be performed across the second dimension of the set of row-wise vectors 215, such as when the second 1D discrete Fourier transform is performed on each vector 215 in the set of row-wise vectors 215. The second 1D discrete Fourier transform is therefore denoted as “N-point DFT_{1D}” in FIG. 2, and the values in a given row are used to perform the N-point discrete Fourier transform. This completes the generation of a 2D discrete Fourier transform of the input feature map 205.

Based on the process 200 illustrated in FIG. 2, it is possible to perform a hybrid 2D discrete Fourier transform in the optical domain. As discussed more fully below, one or more optical systems can be used to perform a 1D discrete Fourier transform on the M rows of the input feature map 205 in conjunction with a 1D discrete Fourier transform on the N columns of the input feature map 205. This type of approach can help to make the determinations of matrix convolutions much more efficient in terms of processing and memory resources.

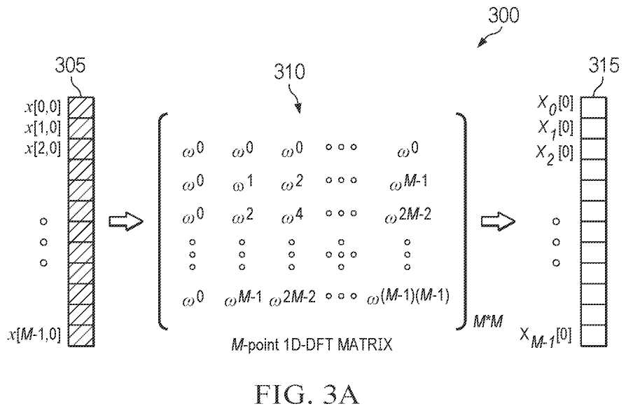

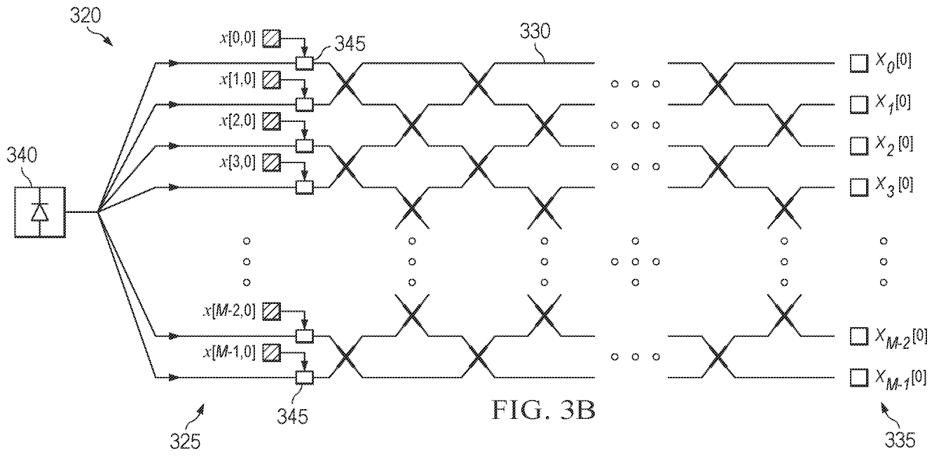

FIGS. 3A and 3B illustrate an example mathematical construct 300 for computing a 1D discrete Fourier transform and an example optical system 320 that implements the 1D discrete Fourier transform according to this disclosure. As shown in FIG. 3A, the mathematical construct 300 represents a 1D discrete Fourier transform performed using an input vector 305. In some cases, the input vector 305 may represent a column-wise vector 210 associated with an input feature map 205 being processed. A 1D discrete Fourier transform using M total points can be expressed as a unitary matrix 310 (which may also be referred to as a unitary transform) of size M×M. The size of the unitary matrix 310 may therefore be defined by the length M of the input vector 305, as opposed to being defined by the values associated with the elements of the input vector 305. The unitary matrix 310 may be applied to the input vector 305 in order to generate an output vector 315, which is an output of a 1D discrete Fourier transform applied to the input vector 305. In some cases, the output vector 315 may represent a row-wise vector 215. Here, the output vector 315 is the Fourier domain representation of the input vector 305.

The unitary matrix 310 may be mapped onto an optical system 320 as illustrated in FIG. 3B. As shown in FIG. 3B, the optical system 320 is configured to implement the 1D discrete Fourier transform illustrated in FIG. 3A. The optical system 320 may be a passive optical network including a plurality of input ports 325, a plurality of optical couplers 330 coupled to the plurality of input ports 325, and a plurality of output ports 335 coupled to the plurality of optical couplers 330. In some instances, the optical system 320 may be referred to as a “coupling network.” The optical system 320 includes a predetermined or other specified number of optical couplers 330 making up the plurality of optical couplers 330. The optical couplers 330 here are arranged to form a 2D array of optical couplers 330. The size of the unitary matrix 310 is defined by the length M of the input vector 305, while the size of the optical network in the optical system 320 may be the same for different input vectors 305 with elements having differing values. In some embodiments, the number of optical couplers 330 in the optical system 320 is equal to (M−1)/2×M. Also, in some embodiments, the optical couplers 330 are 50/50 optical couplers utilizing evanescent wave coupling, multimode interference, or the like.

Embodiments of this disclosure provide several options for changing the input size utilized by the passive optical network, such as by downsizing the size of the DFT matrix. As an example, zero-padding as illustrated in FIG. 1 can be utilized to change the input size of an input matrix. As another example, the coupling ratios between optical couplers 330 in the plurality of optical couplers 330 can be reconfigured to provide a smaller-size input matrix. In some cases, reconfiguration can include reducing the coupling ratio to zero. One of ordinary skill in the art would recognize many variations, modifications, and alternatives.

The optical system 320 may receive an optical signal from a light source 340, which is optically coupled to the plurality of input ports 325 using corresponding waveguides. In some embodiments, the light source 340 represents at least one laser, light emitting diode (LED), pulsed source, or the like. In order to load the values of the elements of the input vector 305 at the plurality of input ports 325, the values of the elements of the input vector 305 (such as x[0, 0], x[1, 0], x[2, 0], . . . , x[M−1, 0]) are used to control corresponding modulators 345. Each modulator 345, controlled by the corresponding element value (x[0, 0], x[1, 0], x[2, 0], . . . , x[M−1, 0]), modulates the optical power passing from the corresponding waveguide (which represents a carrier signal) to the plurality of optical couplers 330. For example, each modulator 345 may be used to modulate the amplitude and the phase of the optical power (carrier signal) provided to the modulator 345. Thus, electrical signals corresponding to the input vector 305 can be used to modulate optical signals provided by the light source 340. In some embodiments, the electrical signals corresponding to the input vector 305 may be pulsed in order to prevent inter-sample interference, where the pulse duration of the electrical signals is shorter than the sample period of the electrical signals. Also, in some embodiments, the light source 340 may be pulsed to prevent inter-sample interference, where the pulse width of the optical power is shorter than the sample period of the electrical signals. As described more fully below, the output of each of the plurality of optical couplers 330 is an optical signal that is provided to a demultiplexer. In some embodiments, electrical outputs are provided by an array of coherent receivers, resulting in a system with electrical inputs and electrical outputs.

In some cases, the input ports 325 can receive fixed and equal optical power from the light source 340. As a particular example, a 105 milliwatt laser or LED used as the light source 340 could be used to provide 1 milliwatt to each of the plurality of input ports 325. In this particular example, modulation of the optical power entering each modulator 345 could result in the output from each modulator 345 varying from 0 milliwatts to 1 milliwatt, depending on the value of the element of the input vector 305 associated with that particular modulator 345. The optical power exiting each of the modulators 345 corresponds to the value of the element of the input vector 305 associated with that particular modulator 345. Accordingly, the values of the elements of the input vector 305 are loaded into the optical network of the optical system 320, which performs a 1D discrete Fourier transform.

The optical signals exiting the plurality of optical couplers 330 are represented by output values X₀[0], X₁[0], X₂[0], . . . , X_{M-1}[0]. These values are representative of the values of the input vector 305 after transformation into the Fourier domain. As a result, the optical signals present at the plurality of output ports 335 may be accessed to retrieve the output vector 315, which is the Fourier transform of the input vector 305.

The first 1D discrete Fourier transform shown in FIG. 2 can be computed using the optical system 320 by loading the values of the elements of the first column-wise vector 210 illustrated in FIG. 2 into the modulators 345 associated with the corresponding elements of the column-wise vector 210. In order to compute 1D discrete Fourier transforms of the remaining column-wise vectors 210, the values of the elements of each remaining column-wise vector 210 are loaded in the modulators 345 associated with the corresponding elements of each remaining column-wise vector 210. Thus, after N cycles for the M×N input feature map 205 shown in FIG. 2, the 1D discrete Fourier transform represented by M-point DFT_{1D} in FIG. 2 is performed. Similarly, the second 1D discrete Fourier transform shown in FIG. 2 can be computed using the optical system 320 by loading the values of the elements of the first row-wise vector 215 illustrated in FIG. 2 into the modulators 345 associated with the corresponding elements of the row-wise vector 215. In order to compute 1D discrete Fourier transforms of the remaining row-wise vectors 215, the values of the elements of each remaining row-wise vector 215 are loaded in the modulators 345 associated with the corresponding elements of each remaining row-wise vector 215.

In this way, using the optical system 320, a physical implementation of a 1D discrete Fourier transform is provided in which the optical system 320 computes the discrete Fourier transform of values that are synchronously loaded using the modulators 345 coupled to the plurality of optical couplers 330. As light propagates through the plurality of optical couplers 330, an array of complex (including real and imaginary parts) discrete Fourier transform coefficients (such as X₀[0], X₁[0], X₂[0], etc.) are computed in the form of the optical signals present at the plurality of output ports 335. As noted above, embodiments of this disclosure utilize a physical network (such as the plurality of optical couplers 330) that remain static independent of the values of the elements of the input vectors 305. Thus, as weights change, the powers of the optical signals output from the modulators 345 change, but the size and layout of the plurality of optical couplers 330 are unchanged. By sequentially loading columns or rows of an input feature map into the optical system 320, a 1D discrete Fourier transform is computed for the input feature map.

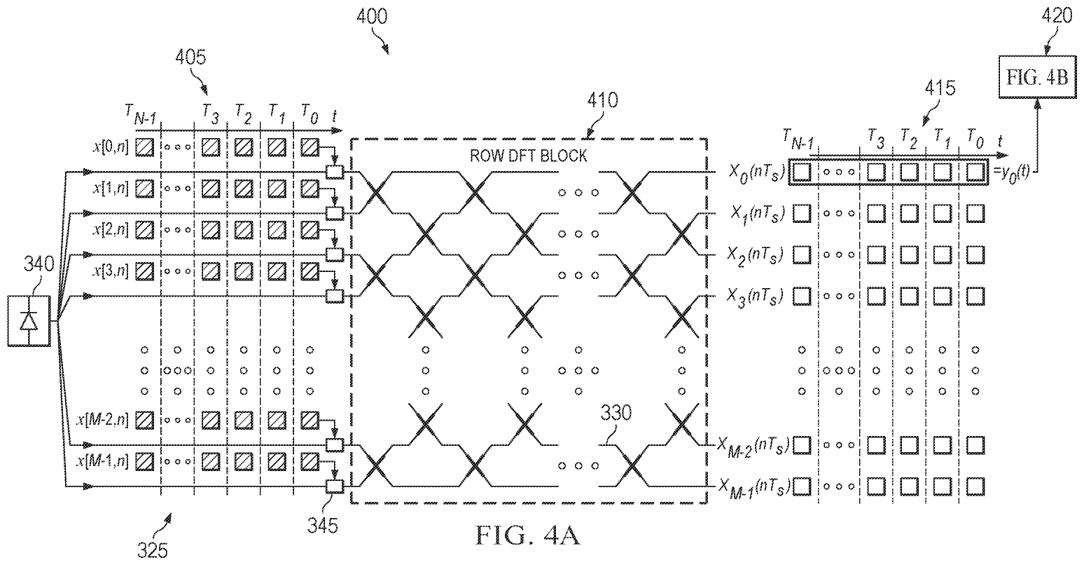

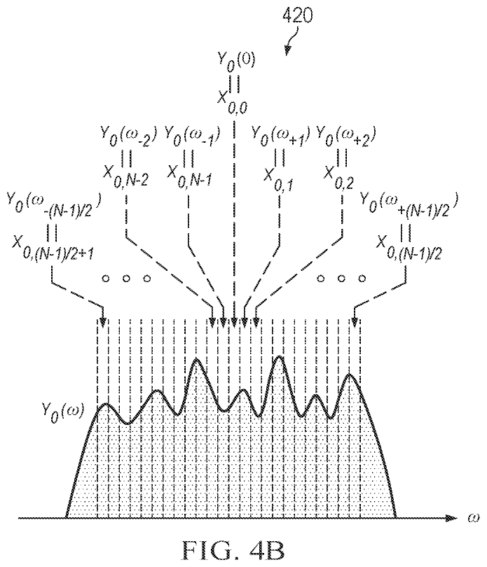

FIGS. 4A and 4B illustrate an example 2D discrete Fourier transform computation using an optical system 400 and an example frequency spectrum 420 associated with the 2D discrete Fourier transform according to this disclosure. As shown in FIG. 4A, values of elements in columns (such as the column-wise vectors 210) of an input feature map (such as the input feature map 205) can be sequentially loaded using the modulators 345, which may occur in the same or similar manner as discussed above with reference to FIG. 3B. As a result, a time series of element values within a time series set 405 can be provided to each modulator 345. Values of the elements in the columns of the input feature map are illustrated by M values in the first column of the time series set 405 at time T₀, M values in the second column of the time series set 405 at time T₁, and so on up to the M values in the N^{th} column of the time series set 405 at time T_{N-1}.

As can be seen in FIG. 4A, to compute the discrete Fourier transform across the rows of a 2D input feature map (such as the input feature map 105 or the zero-padded input feature map 115 of FIG. 1), samples for the rows in each column of the input feature map are time-serialized, such as with a sampling period T_{S}, to produce the time series set 405. The values in the time series set 405 are fed into the plurality of input ports of a row DFT block 410. The row DFT block 410 here represents an optical network formed by the various optical couplers 330 shown in FIG. 3B and described above. After each time period T_{S}, 1D discrete Fourier transform coefficients along each column of the input feature map are generated. This produces a time series of 1D Fourier coefficients for each column in a time series set 415. The time series of 1D Fourier coefficients within the time series set 405 are illustrated as being associated with times T₀, T₁, T₂, . . . , T_{N-1}.

If each time series of 1D Fourier coefficients in the time series set 415 of 1D Fourier coefficients is considered as a function y₀(t), the Fourier transform of the time series will have a frequency spectrum Y₀(ω) 420. The frequency spectrum 420 is illustrated in FIG. 4B. Thus, the frequency spectrum 420 of each time series in the time series set 415 represents the Fourier transform along the second dimension (such as the rows of the input feature map). Accordingly, by computing the short-term Fourier transform of the time series, the 2D discrete Fourier transform of the input feature map is computed.

Note that, in FIGS. 3B and 4A, a single light source 340 is illustrated, which in some cases may provide input light at a single wavelength or within a single narrow wavelength range. However, as described below, a multi-wavelength source can also be utilized to perform a short-term Fourier transform of a time series.

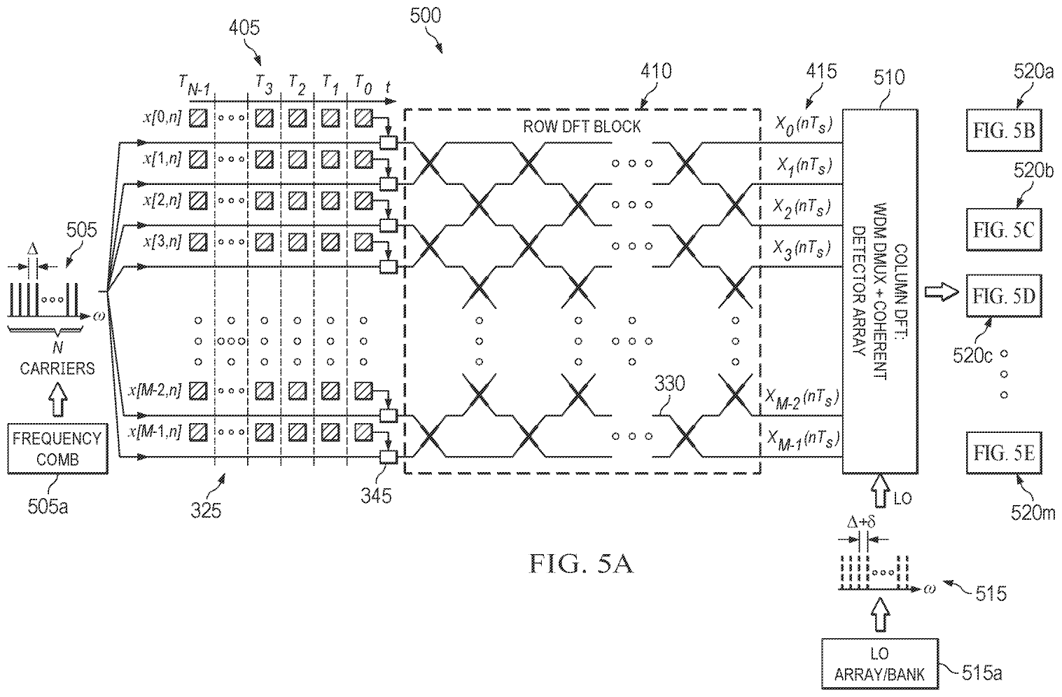

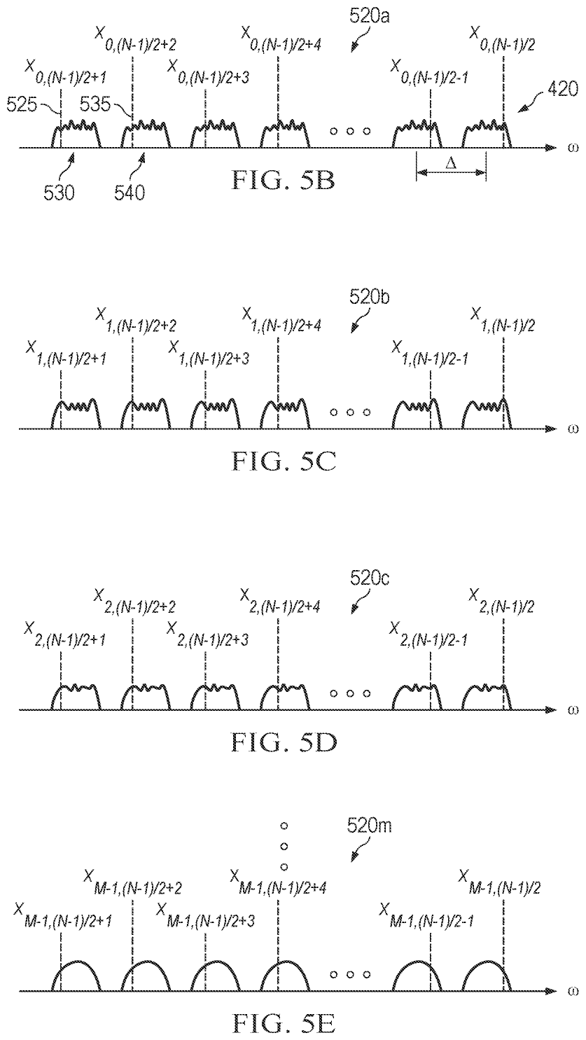

FIGS. 5A through 5E illustrate another example 2D discrete Fourier transform computation using an optical system 500 and example frequency spectra 520a-520m associated with the 2D discrete Fourier transform according to this disclosure. As shown in FIG. 5A, rather than computing a short-time Fourier transform digitally (which may increase power consumption), the second 1D discrete Fourier transform of the 1D Fourier coefficients represented by the function y₀(t) into the frequency spectrum Y₀(ω) can be performed by physical Fourier decomposition via coherent detection using a phase-coherent carrier array. In this example, for an M×N input feature map (such as the input feature map 105 or the zero-padded input feature map 115), an N-tone carrier array 505 is used, which may be provided in some cases by a frequency comb 505a with a carrier frequency spacing equal to Δ. That is, the frequency comb 505a may generate N optical signals having frequencies that are equally spaced by Δ (although it is possible for combs to have different frequency spacings). The carrier array 505/frequency comb 505a here may be used as the input light source in place of the light source 340 discussed above. Each carrier signal in the N-tone carrier array 505 may be used to modulate the same input value (such as the same element of a column-wise vector 210 of an input feature map), thereby duplicating the discrete Fourier transform coefficients computed in the row DFT block 410 into N spectrally-distinct copies. As shown in FIG. 5B, for example, six copies of the frequency spectrum 420 (of the N copies) are illustrated as a frequency domain signature (frequency spectrum 520a). In this example, the spacing between each adjacent pair of the six copies is equal to the carrier frequency spacing A.

Because the M values for the input vector are entered synchronously, the discrete Fourier transform coefficients computed to provide each time series in the time series set 415 are produced synchronously. Thus, as shown in FIGS. 5C through 5E, six copies of the frequency spectrum corresponding to X₁(nTₛ) are contained in a frequency domain signature (frequency spectrum 520b), six copies of the frequency spectrum corresponding to X₂(nTₛ) are contained in a frequency domain signature (frequency spectrum 520c), and six copies of the frequency spectrum corresponding to X_{M-1}(nTₛ) are contained in a frequency domain signature (frequency spectrum 520m). Here, N spectrally-distinct copies of the frequency spectrum for each time series of discrete Fourier transform coefficients are provided in a set of M frequency domain signatures 520a-520m.

Referring again to FIG. 5A, a column DFT block 510 can be used to implement a coherent detector array with an equivalent bandwidth of N/T_{S} (such as a low-speed coherent detector array). The column DFT block 510 is used with a phase-coherent carrier array 515 with an offset frequency spacing of δ=N/T_{S} from a local oscillator (LO) array or bank 515a. Thus, the optical signals in the phase-coherent carrier array 515 have frequencies that are equally spaced by Δ+δ (although it is possible for these optical signals to have different frequency spacings). In this arrangement, the output of each coherent detector set represents short-time Fourier transform coefficients of the discrete Fourier transform time series, thereby resulting in the computation of the second 1D discrete Fourier transform and providing the 2D discrete Fourier transform of the input feature map as an output.

As an example of this, as shown in FIG. 5B, a first frequency 525 provided in the phase-coherent carrier array 515 from the LO array or bank 515a can be used to sample a first frequency spectrum 530 of the N spectrally-distinct copies of the frequency spectrum present in the first frequency domain signature (spectrum 520a), a second frequency 535 can be used to sample a second frequency spectrum 540 of the N spectrally-distinct copies of the frequency spectrum present in the first frequency domain signature (spectrum 520a), etc. Accordingly, since the carrier frequency spacing between carriers provided by the LO array or bank 515a is equal to Δ+δ, the frequencies provided by the LO array or bank 515a can be used to sample the frequency spectrum across the breadth of the frequency spectrum. Thus, the output of the column discrete Fourier transform block 510 is a sampled set of Fourier coefficients. Accordingly, the Fourier coefficients sampled using the LO array or bank 515a are the desired short-time Fourier transform coefficients.

In the example shown in FIGS. 4A and 4B, the sampled output of the first frequency domain signature corresponds to the frequency spectrum Y₀(ω). Because all M columns are loaded synchronously, the frequency spectra associated with each of the M columns are produced synchronously in FIG. 5A, resulting in the 2D discrete Fourier transform of the input feature map as an output. Note that while the column DFT block 510 follows the row DFT block 410 here, the positions of the DFT blocks 410 and 510 could be reversed, effectively interchanging the order of the row DFT and the column DFT. As a result, the order of operations can be modified, and the particular implementation illustrated in FIG. 5A is merely one possible example implementation.

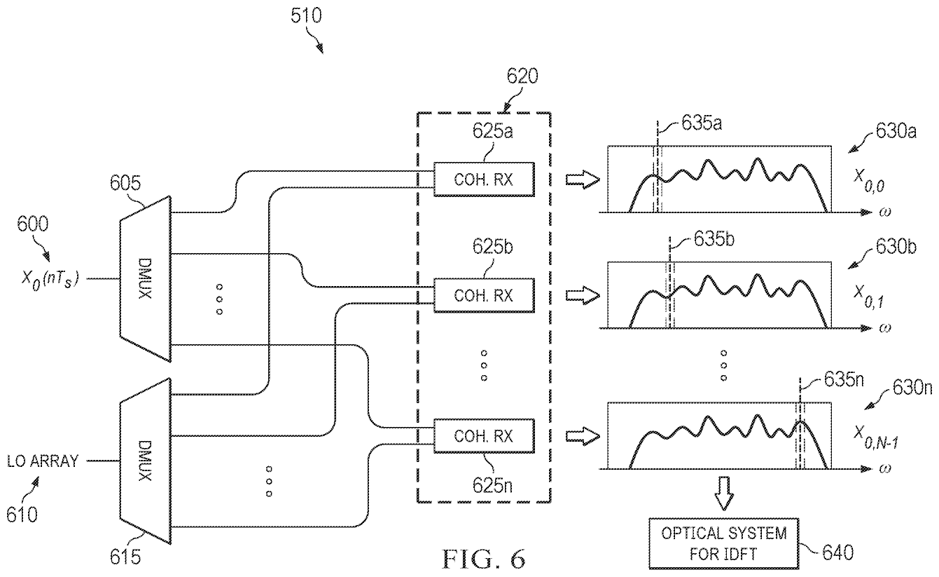

FIG. 6 illustrates an example implementation of a column DFT block 510 according to this disclosure. As discussed above in relation to FIG. 5A, the column DFT block 510 is used to perform the second 1D discrete Fourier transform (or the first 1D discrete Fourier transform if the DFT blocks 410 and 510 are reversed). As shown in FIG. 6, a time series 600 (which may represent one of the time series in the time series set 415) may be fed into a demultiplexer (DMUX) 605 to be split into N spectrally-distinct copies (such as the N spectrally-distinct copies included in the frequency spectrum 520a shown in FIG. 5B). Thus, each of the spectrally-distinct copies illustrated by the first frequency spectrum 530 and the second frequency spectrum 540 in FIG. 5B will be demultiplexed to provide separate copies of the frequency spectrum.

The outputs of the demultiplexer 605 (the spectrally-distinct copies of the frequency spectrum 420) are provided as inputs to a coherent detector array 620. As illustrated in FIG. 6, the coherent detector array 620 includes a plurality of coherent detectors 625a-625n, which may also be referred to as coherent receivers. A signal 610 (such as the phase-coherent carrier array 515) from the LO array or bank 515a may be fed into a demultiplexer 615, which feeds a first frequency provided by the LO array or bank 515a into the first coherent detector 625a, a second frequency provided by the LO array or bank 515a into the second coherent detector 625b, and so on through an N^{th} frequency provided by the LO array or bank 515a into the n^{th} coherent detector 625n. Thus, each of the frequencies illustrated by the first frequency 525 and the second frequency 535 in FIG. 5B can be demultiplexed to provide the frequencies present in the phase-coherent carrier array 515. In some cases, a number of the carrier signals in the N-tone carrier array 505, a number of the carrier signals in the phase-coherent carrier array 515, and a number of the coherent detectors 625a-625n in the coherent detector array 620 are equal.

Each of the coherent detectors 625a-625n in the coherent detector array 620 can multiply the frequency spectrum output by the demultiplexer 605 with the frequency output by the demultiplexer 615. Since the coherent detectors 625a-625n are band-limited receivers, this multiplication is effectively an integration of the frequency spectrum over the narrow frequency range associated with the particular frequency output by the demultiplexer 615. Accordingly, as illustrated by a frequency spectrum 630a and a frequency 635a, a frequency spectrum 630b and a frequency 635b, and a frequency spectrum 630n and a frequency 635n, the frequencies provided by the LO array or bank 515a can be used to sample the frequency spectrum 420 across the breadth of the frequency spectrum 420 and produce the short-time Fourier transform coefficients. As there are M total time series coming from the row DFT block 410 into the column DFT block 510 as shown in FIG. 5A, the process in FIG. 6 may be repeated M times to complete the 2D discrete Fourier transform of the M×N input feature map. In some embodiments, the structure shown in FIG. 6 can be replicated M times so that the M time series in the time series set 415 can be processed synchronously. In those embodiments, there can be an array of demultiplexers 605, an array of demultiplexers 615, and multiple coherent detector arrays 620.

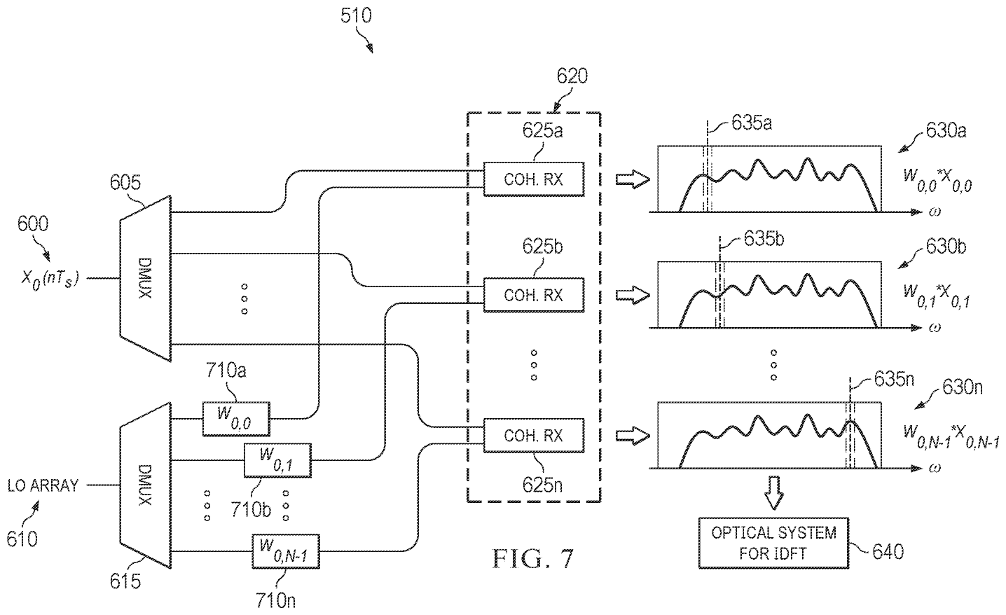

FIG. 7 illustrates an example implementation of a column DFT block 510 incorporating weighting according to this disclosure. As an extension of the column DFT block 510 discussed in relation to FIG. 6, the 2D convolution can be further computed within the coherent detector array 620 of the column DFT block 510 by modulating each frequency provided by the LO array or bank 515a with a precomputed or otherwise specified Fourier equivalence of a weight matrix (such as the weight map 110 or the zero-padded weight map 120 illustrated in FIG. 1).

As shown in FIG. 7, the frequencies output by the demultiplexer 615 are multiplied by corresponding weight coefficients, thereby multiplying each 2D discrete Fourier transform coefficient with the corresponding weight coefficient. In some embodiments, the weight coefficients are Fourier space weights. In the example shown in FIG. 7, the first frequency provided by the LO array or bank 515a is weighted by a first weight W_{0,0} using a first weighting element 710a prior to delivery to the first coherent detector 625a, the second frequency provided by the LO array or bank 515a is weighted by a second weight W_{0,1} using a second weighting element 710b prior to delivery to the second coherent detector 625b, and so on until the N^{th} frequency provided by the LO array or bank 515a is weighted by an N^{th} weight W_{0,N-1} using an N^{th} weighting element 710n prior to delivery to the N^{th} coherent detector 625n. In some embodiments, the weighting elements 710a-710n can be implemented using tunable optical attenuators, phase shifters, or the like or as elements that modify the phase and/or the amplitude of the frequencies output by the demultiplexer 615. In this way, the frequencies provided by the LO array or bank 515a can be used to sample the frequency spectrum 420 across the breadth of the frequency spectrum 420 while weighting the sampling using the corresponding weights, thereby resulting in N outputs equal to W_{0,0}×X_{0,0}, W_{0,1}×X_{0,1}, . . . , W_{0,N-1}×X_{0,N-1}. Again, in some embodiments, the structure shown in FIG. 7 can be replicated M times so that the M time series in the time series set 415 can be processed synchronously. In those embodiments, there can be an array of demultiplexers 605, an array of demultiplexers 615, multiple coherent detector arrays 620, and multiple collections of weighting elements 710a-710n. Thus, for example, weights W_{1,0}-W_{1,N-1} would be used with the time series X_{1,0}-X_{1,N-1}, and weights W_{N-1,0}-W_{N-1,N-1} would be used with the time series X_{N-1,0}-X_{N-1,N-1}.

Since the weights may be relatively stable, in some embodiments, the 2D discrete Fourier transform of the weights may be performed once, and the results can be stored for later use in the various embodiments of the systems described here. Accordingly, the row DFT block 410 and the column DFT block 510 can be utilized to generate a Fourier space weight map, and the coefficients of the Fourier space weight map can be stored for later use. Alternatively, since the weights are relatively stable, conventional systems could be utilized to compute the Fourier space weight map, which can be stored in a memory. In FIG. 7, the illustrated weights W_{0,0}, W_{0,1}, . . . , W_{0,N-1} correspond to the Fourier space weight map present at the output of the second 2D discrete Fourier transform unit 130 illustrated in FIG. 1. Thus, the output provided by the coherent detector array 620 corresponds to output of the Hadamard Multiplier 135 illustrated in FIG. 1.

The resultant convolution product provided by the coherent detector array 620 may be converted from Fourier space into real space, such as by passing the output of the coherent detector array 620 to a second optical system 640. The second optical system 640 can be similar to the one described in FIGS. 5A and 6, such as the complete optical system of FIG. 5A without the weighting matrix. The second optical system 640 can perform an inverse two-dimensional discrete Fourier transform, such as by rotating its inputs accordingly. One of ordinary skill in the art would recognize many variations, modifications, and alternatives.

As one particular example use case of the described approaches, a video stream can be received and processed using embodiments of this disclosure. The video stream, which includes data that is changing rapidly, can be received as one or more input feature maps 105. A weight map appropriate for image processing, which may include data that is not changing rapidly, can be received as a weight map 110. Using the embodiments of this disclosure, the video stream can be processed at high speed and low computational complexity using the optical systems described above. Note that, in addition to image processing applications, other applications that utilize neural networks, convolutional networks, or other convolutions (such as systems supporting voice analysis, signature analysis, and the like) may use various implementations of the embodiments described above.

Embodiments of this disclosure can provide significant benefits or advantages, such as in relation to system size and complexity, in comparison with conventional optical matrix multipliers. For example, for a 64×64 input feature map and a 3×3 weight map, an optical matrix multiplier may utilize a 4,356×4,356 U matrix (corresponding to 9,485,190 tunable optical couplers), a 4,096×4,096 V matrix (corresponding to 8,386,560 tunable optical couplers), and a 64×64 D matrix (corresponding to 64 variable optical attenuators). Assuming an optical coupler size of 15 μm×15 μm and a detector size of 50 μm×105 μm limited by bump pitch, the total size of the optical matrix multiplier could be on the order of about 4,122 mm².

In some implementations, embodiments of this disclosure providing the same functionality may implement two 66×66 discrete Fourier transform matrices to perform discrete Fourier transformation and inverse discrete Fourier transformation, respectively. This could correspond to 4,290 fixed optical couplers, four 66×66 channel wavelength division multiplexing (WDM) arrays (two per discrete Fourier transform and two per inverse discrete Fourier transform) corresponding to 17,424 ring filters, and a 66×66 weight matrix corresponding to 4,356 complex (such as I/Q) modulators. Assuming an optical coupler size of 15 μm×15 μm, a ring filter size of 30 μm×10 μm, and coherent detector size of 105 μm×105 μm limited by bump pitch, the total size of this implementation would be on the order of about 93.3 mm². In addition to significant size savings, the power consumption of embodiments of this disclosure is much lower than that associated with optical matrix multipliers, since many of the components in the embodiments of this disclosure are passive.

Although FIGS. 1 through 7 illustrate examples of discrete Fourier transforms, optical systems that implement discrete Fourier transforms, signal spectra, and related details, various changes may be made to FIGS. 1 through 7. For example, each of the input feature maps 105, 115, 205 and weight maps 110, 120 may have any suitable dimensions. Also, an optical system may include any suitable number of each component shown in the figures. In addition, in each optical system illustrated, various components may be combined, further subdivided, replicated, omitted, or rearranged and additional components may be added according to particular needs.

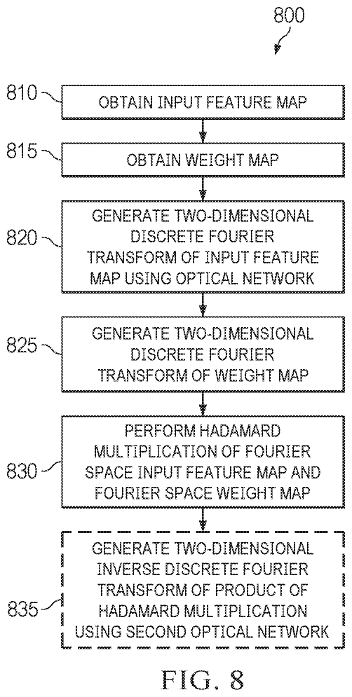

FIG. 8 illustrates an example method 800 for performing convolutions using an optical network according to this disclosure. For ease of explanation, the method 800 may be performed using any of the optical systems described above. However, the method 800 may be performed using any other suitable optical system designed in accordance with this disclosure.

As shown in FIG. 8, an input feature map is obtained at step 810, and a weight map is obtained at step 815. This may include, for example, receiving, generating, or otherwise obtaining an input feature map 105 associated with input data being processed and receiving, generating, or otherwise obtaining a weight map 110 to be applied to the input data being processed. A two-dimensional discrete Fourier transform of the input feature map is generated to produce a Fourier-space input feature map at step 820. This may include, for example, using any of the optical networks described above to convert the input feature map 105, 205 (or the zero-padded input feature map 115) into a Fourier-space input feature map. A two-dimensional Fourier transform of the weight map is generated to produce a Fourier-space weight map at step 825. This may include, for example, using any of the optical networks described above to convert the weight map 110 (or the zero-padded weight map 120) into a Fourier-space weight map. A Hadamard multiplication of the Fourier-space input feature map and the Fourier-space weight map is performed at step 830. This may include, for example, the optical network outputting optical signals that represent the 2D discrete Fourier transform of the input feature map.

In some embodiments, a second optical network may be used to perform a two-dimensional inverse discrete Fourier transform of the output produced by the Hadamard multiplication at step 835. For example, the optical system 640 may be used to perform the 2D IDFT process. The output of the 2D inverse discrete Fourier transform can provide a convolution of the input feature map 105 and the weight map 110. Also, in some embodiments, zero-padding an input map may occur in order to generate the input feature map, and zero-padding a weighting map may occur in order to generate the weight map (which can occur prior to or during steps 810 and 815). In addition, in some embodiments, the Fourier-space weight map may be generated and stored in memory, and the Fourier-space weight map may be retrieved at step 825 from the memory and utilized to weight local oscillator carriers.

Although FIG. 8 illustrates one example of a method 800 for performing convolutions using an optical network, various changes may be made to FIG. 8. For example, while shown as a series of steps, various steps in FIG. 8 may overlap, occur in parallel, occur in a different order, or occur any number of times. Moreover, the individual steps in FIG. 8 may include multiple sub-steps that may be performed in various sequences as appropriate to the individual step. In addition, various steps may be added to or removed from the method 800 depending on the particular applications. One of ordinary skill in the art would recognize many variations, modifications, and alternatives.

The following describes example embodiments of this disclosure that implement or relate to methods and systems for performing convolutions using optical networks. However, other embodiments may be used in accordance with the teachings of this disclosure.

In a first embodiment, an apparatus includes a frequency comb configured to generate multiple first carrier signals having at least one first frequency spacing. The apparatus also includes multiple modulators configured to modulate the first carrier signals, where each modulator is configured to modulate a corresponding one of the first carrier signals based on a time series of values from a corresponding portion of a matrix. In addition, the apparatus includes an array of optical couplers configured to perform one-dimensional (1D) discrete Fourier transforms of the portions of the matrix using the modulated first carrier signals, where the array of optical couplers is configured to output a time series of 1D Fourier coefficients for each time series of values from the corresponding portion of the matrix.

Any single one or any suitable combination of the following features may be used with the first embodiment. The array of optical couplers may be configured to duplicate each time series of 1D Fourier coefficients into multiple spectrally-distinct copies based on different frequencies of the first carrier signals. The apparatus may also include coherent detectors configured to sample the time series of 1D Fourier coefficients based on second carrier signals, and the second carrier signals may have at least one second frequency spacing larger than the at least one first frequency spacing. The coherent detectors may be configured to output short-time Fourier transform coefficients of the time series of 1D Fourier coefficients, and the short-time Fourier transform coefficients may represent a 2D discrete Fourier transform of the matrix. The apparatus may also include, for each time series of 1D Fourier coefficients from the array of optical couplers, a first demultiplexer configured to separate multiple spectrally-distinct copies of the time series of 1D Fourier coefficients and to provide different ones of the spectrally-distinct copies to different ones of the coherent detectors. The apparatus may also include a local oscillator (LO) bank or array configured to generate the second carrier signals and, for each time series of 1D Fourier coefficients from the array of optical couplers, a second demultiplexer configured to separate the second carrier signals and to provide different ones of the second carrier signals to different ones of the coherent detectors. The apparatus may also include weighting elements configured to adjust the second carrier signals based on different weights and to provide the adjusted second carrier signals to the coherent detectors. The matrix may include an input feature map, and the weights may be from a weight map. The time series of values from the corresponding portions of the matrix may correspond to column-wise vectors from the matrix, and the time series of 1D Fourier coefficients from the array of optical couplers sampled by the coherent detectors may include row-wise vectors.

In a second embodiment, an apparatus includes a frequency comb configured to generate first carrier signals having at least one first frequency spacing. The apparatus also includes multiple modulators each configured to modulate an amplitude of one of the first carrier signals and generate a modulated carrier signal. The apparatus further includes a two-dimensional (2D) array of optical couplers configured to perform 1D discrete Fourier transforms in a first direction using the modulated carrier signals. The apparatus also includes an array of coherent detectors and first demultiplexers optically coupled to outputs of the array of optical couplers and to the coherent detectors. The apparatus further includes a local oscillator (LO) bank or array configured to generate second carrier signals having at least one second frequency spacing different from the at least one first frequency spacing. In addition, the apparatus includes second demultiplexers optically coupled to outputs of the LO bank or array and to the coherent detectors.

Any single one or any suitable combination of the following features may be used with the second embodiment. Each coherent detector may be configured to receive an output of one of the first demultiplexers and an output of one of the second demultiplexers and to generate a Fourier coefficient. The array of coherent detectors may be configured to output a second 1D discrete Fourier transform in a second direction to complete a 2D discrete Fourier transform on an input of the apparatus. The optical couplers may include 50/50 optical couplers. A number of the first carrier signals, a number of the second carrier signals, and a number of coherent detectors in the array of coherent detectors may be equal. The apparatus may also include weighting elements configured to modulate the second carrier signals according to a weight matrix. A Fourier equivalent weight matrix of the weight matrix may be pre-computed and stored by the apparatus.

In a third embodiment, a method includes obtaining an input feature map and generating, using an optical network, a 2D discrete Fourier transform of the input feature map to produce a Fourier-space input feature map. The method also includes obtaining a Fourier-space weight map based on a weight map and performing a Hadamard multiplication of the Fourier-space input feature map and the Fourier-space weight map.

Any single one or any suitable combination of the following features may be used with the third embodiment. The method may also include generating, using a second optical network, a 2D inverse discrete Fourier transform of an output of the Hadamard multiplication. An output of the 2D inverse discrete Fourier transform may include a convolution of the input feature map and the weight map. The method may also include generating, using the optical network, a 2D discrete Fourier transform of the weight map to produce the Fourier-space weight map and storing coefficients of the Fourier-space weight map. The method may also include zero-padding an input map to produce the input feature map and a weighting map to provide the weight map. The method may also include receiving the Fourier-space weight map, storing the Fourier-space weight map, retrieving the Fourier-space weight map from storage, and utilizing the Fourier-space weight map to weight LO carrier signals.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a frequency comb configured to generate multiple first carrier signals having at least one first frequency spacing;
multiple modulators configured to modulate the first carrier signals, each modulator configured to modulate a corresponding one of the first carrier signals based on a time series of values from a corresponding portion of a matrix; and
an array of optical couplers configured to perform one-dimensional (1D) discrete Fourier transforms of the portions of the matrix using the modulated first carrier signals, the array of optical couplers configured to output a time series of 1D Fourier coefficients for each time series of values from the corresponding portion of the matrix.

2. The apparatus of claim 1, wherein the array of optical couplers is configured to duplicate each time series of 1D Fourier coefficients into multiple spectrally-distinct copies based on different frequencies of the first carrier signals.

3. The apparatus of claim 1, further comprising:
coherent detectors configured to sample the time series of 1D Fourier coefficients based on second carrier signals, the second carrier signals having at least one second frequency spacing larger than the at least one first frequency spacing;
wherein the coherent detectors are configured to output short-time Fourier transform coefficients of the time series of 1D Fourier coefficients, the short-time Fourier transform coefficients representing a two-dimensional (2D) discrete Fourier transform of the matrix.

4. The apparatus of claim 3, further comprising:
for each time series of 1D Fourier coefficients from the array of optical couplers, a first demultiplexer configured to separate multiple spectrally-distinct copies of the time series of 1D Fourier coefficients and to provide different ones of the spectrally-distinct copies to different ones of the coherent detectors.

5. The apparatus of claim 4, further comprising:
a local oscillator (LO) bank or array configured to generate the second carrier signals; and
for each time series of 1D Fourier coefficients from the array of optical couplers, a second demultiplexer configured to separate the second carrier signals and to provide different ones of the second carrier signals to different ones of the coherent detectors.

6. The apparatus of claim 5, further comprising:
weighting elements configured to adjust the second carrier signals based on different weights and to provide the adjusted second carrier signals to the coherent detectors.

7. The apparatus of claim 6, wherein:
the matrix comprises an input feature map; and
the weights are from a weight map.

8. The apparatus of claim 1, wherein:
the time series of values from the corresponding portions of the matrix correspond to column-wise vectors from the matrix; and
the time series of 1D Fourier coefficients from the array of optical couplers sampled by the coherent detectors comprise row-wise vectors.

9. An apparatus comprising:
a frequency comb configured to generate first carrier signals having at least one first frequency spacing;
multiple modulators each configured to modulate an amplitude of one of the first carrier signals and generate a modulated carrier signal;
a two-dimensional (2D) array of optical couplers configured to perform one-dimensional (1D) discrete Fourier transforms in a first direction using the modulated carrier signals;
an array of coherent detectors;
first demultiplexers optically coupled to outputs of the array of optical couplers and to the coherent detectors;
a local oscillator (LO) bank or array configured to generate second carrier signals having at least one second frequency spacing different from the at least one first frequency spacing; and
second demultiplexers optically coupled to outputs of the LO bank or array and to the coherent detectors.

10. The apparatus of claim 9, wherein:
each coherent detector is configured to receive an output of one of the first demultiplexers and an output of one of the second demultiplexers and to generate a Fourier coefficient; and
the array of coherent detectors is configured to output a second one-dimensional (1D) discrete Fourier transform in a second direction to complete a 2D discrete Fourier transform on an input of the apparatus.

11. The apparatus of claim 9, wherein the optical couplers comprise 50/50 optical couplers.

12. The apparatus of claim 9, wherein a number of the first carrier signals, a number of the second carrier signals, and a number of coherent detectors in the array of coherent detectors are equal.

13. The apparatus of claim 9, further comprising:
weighting elements configured to modulate the second carrier signals according to a weight matrix.

14. The apparatus of claim 13, wherein a Fourier equivalent weight matrix of the weight matrix is pre-computed and stored by the apparatus.

15. A method comprising:
obtaining an input feature map;
generating, using an optical network, a two-dimensional (2D) discrete Fourier transform of the input feature map to produce a Fourier-space input feature map;
obtaining a Fourier-space weight map based on a weight map; and
performing a Hadamard multiplication of the Fourier-space input feature map and the Fourier-space weight map.

16. The method of claim 15, further comprising:
generating, using a second optical network, a 2D inverse discrete Fourier transform of an output of the Hadamard multiplication.

17. The method of claim 16, wherein an output of the 2D inverse discrete Fourier transform comprises a convolution of the input feature map and the weight map.

18. The method of claim 17, further comprising:
generating, using the optical network, a 2D discrete Fourier transform of the weight map to produce the Fourier-space weight map; and
storing coefficients of the Fourier-space weight map.

19. The method of claim 15, further comprising:
zero-padding an input map to produce the input feature map and a weighting map to provide the weight map.

20. The method of claim 15, further comprising:
receiving the Fourier-space weight map;
storing the Fourier-space weight map;
retrieving the Fourier-space weight map from storage; and
utilizing the Fourier-space weight map to weight local oscillator (LO) carrier signals.
